(19) United States
(12) Patent Application Publication
(10) Pub. No.: US 2019/0337719 A1
(43) Pub. Date: Nov. 7, 2019

(54) Systems and methods for automated storage and retrieval of objects

(71) Applicant: Walmart Apollo, LLC, Bentonville, AR (US)

(72) Inventors: David G. Tovey, Rogers, AR (US); John Simon, Pembroke Pines, FL (US); Kurt William Robert Bessel, Mexico, NY (US); Bruce W. Wilkinson, Rogers, AR (US)

(21) Appl. No.: 16/394,677

(22) Filed: Apr. 25, 2019

Related U.S. Application Data
(60) Provisional application No. 62/667,079, filed on May 4, 2018.

(51) Int. Cl. B65G 1/137; G07F 17/12; B65G 1/06; G07F 11/16

(52) U.S. Cl. CPC B65G 1/137; G07F 17/12; B65G 2203/044; G07F 11/165; B65G 1/06

(57) ABSTRACT

Systems and methods are described in detail herein for storage and retrieval of objects. The systems and methods allow for automated object retrieval and storage by a user without the need for intervention of a facility employee. Systems and methods described herein place the crane external to storage towers to allow a central shaft of the tower to be used to store objects. Advantageously, storage towers in systems of the present disclosure can include sections of different sizes that can store large objects and objects of varying sizes on a single storage tower. System and methods described herein provide a transport platform that can enable expanded storage in a single machine by translating or rotating multiple storage towers to bring the requested tower proximate to the crane and dispensing window.

### CROSS REFERENCE TO RELATED APPLICATION

This application claims priority to U.S. Provisional Application No. 62/667,079, filed May 4, 2018, the entire contents of this application being incorporated herein by reference.

### BACKGROUND

Customers increasingly prefer the use self-service systems to complete or conduct transactions in a physical retail environment.

### BRIEF DESCRIPTION OF DRAWINGS

Illustrative embodiments are shown by way of example in the accompanying drawings and should not be considered as a limitation of the present disclosure.

FIG. 1 illustrates a prior art system for storage and retrieval.

FIG. 2 illustrates a top schematic view of a storage and retrieval system in accordance with embodiments described herein.

FIG. 3 illustrates a top schematic view of an embodiment of a storage and retrieval system including translating storage towers.

FIGS. 4A and 4B illustrate side and top schematic views, respectively, of an exemplary storage tower in accordance with various embodiments described above.

FIG. 5 illustrates a front schematic view of a dispensing window in accordance with various embodiments described herein.

FIG. 6 illustrates a block diagram of an object storage and retrieval system in accordance with an exemplary embodiment.

FIG. 7 illustrates a block diagram of an exemplary computing device in accordance with an exemplary embodiment.

FIG. 8 illustrates a flowchart for a method of storing and delivering objects in accordance with embodiments described herein.

FIG. 9 illustrates a flowchart for a method of storing objects in accordance with embodiments described herein.

FIG. 10 illustrates a flowchart for a method of simultaneous storage of objects in accordance with embodiments described herein.

### DETAILED DESCRIPTION

Described in detail herein are systems and methods for storage and/or retrieval of objects. The systems and methods allow for automated object storage and/or retrieval by a user without the need for intervention of a facility employee. Conventional systems for automated storage and/or retrieval typically include a tower having housing or wall(s) that define an interior volume. In such conventional systems, a crane to retrieve and store objects is typically disposed within the interior volume at the center of the tower, and objects for retrieval are stored circumferentially around the crane. This arrangement wastes significant space at the center of the tower that must be held open for the crane to operate.

Systems and methods described herein place a crane external to the tower to allow a central shaft of the tower to be used to store objects. Advantageously, storage towers in systems of the present disclosure include sections of different dimensions/sizes that can store large objects and objects of varying sizes in a single storage tower. System and methods described herein provide a transport platform that can enable expanded storage in a single machine by translating or rotating multiple storage towers to bring a requested tower proximate to the crane and a dispensing window. Using this approach, the systems and methods described herein can also advantageously utilize a single crane for multiple storage towers.

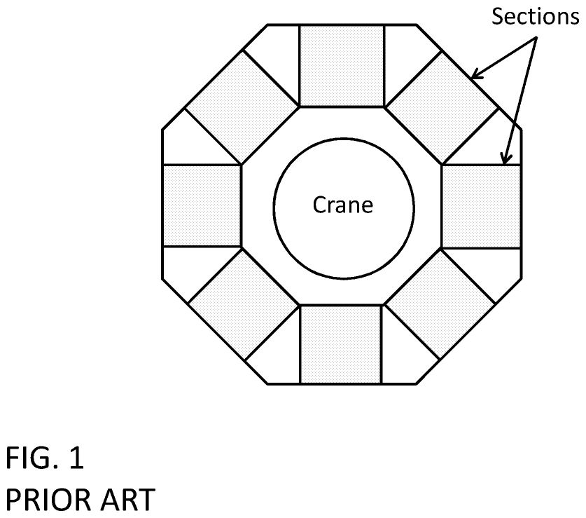

FIG. 1 illustrates a prior art system for object storage and retrieval. In conventional systems, a storage tower includes sections where objects can be stored are placed at a perimeter surrounding a centrally located crane. The crane can lift the objects and rotate about its axis to access any of the sections around the perimeter. This arrangement is complicated and requires a more expensive and complex crane component to rotate and lift. In addition, the central shaft of the storage tower must remain empty and open to allow the crane and the objects it transports to pass through. Moreover, tower sections in the conventional device uniformly accommodate only a single object width.

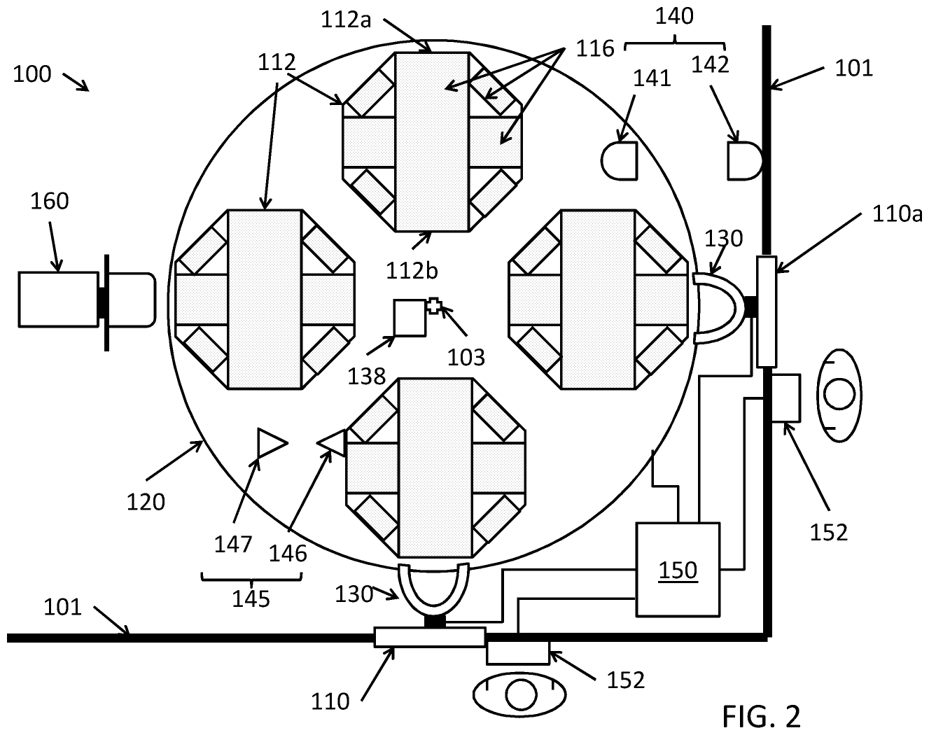

FIG. 2 illustrates a top schematic view of a storage and retrieval system in accordance with embodiments described herein. The storage and retrieval system 100 includes storage towers 112, a dispensing window 110, a transport platform 120, and a crane 130. The transport platform 120 is configured to support the plurality of towers 112 and to position at least one of the storage towers 112 proximate to the dispensing window 110. In some embodiments, the transport platform 120 can be a circular disk, an annular ring, or a circular track. The crane 130 is configured to selectively retrieve at least one object from one of the storage towers 112 and to deliver the object to the dispensing window 110. Positioning of one of the storage towers proximate to the dispensing window can occur in response to input from a user. Advantageously, the system 100 can provide storage for objects of different dimensions/sizes and can enable object retrieval from one of the towers 112 at the same time that different objects are loaded onto one or more of the other towers.

Each of the storage towers 112 can include sections 116. In some embodiments, the sections 116 can have different widths, depths, heights, or volumes, and/or can have different structure arrangements for storing objects. In some embodiments, each of the storage towers 112 can include at least three sections 116. For example, the storage tower 112 can include small, intermediate, and large sections 116. In some embodiments, the depth of at least one of the sections 116 can be equal to a distance between a first side 112a of the storage tower and a second side 112b of the storage tower opposite the first side (e.g., a width or diameter of the tower). In some embodiments, each of the sections 116 can have a same shape. For example, the storage towers 112 can be divided into “pie pieces” where each piece of the pie represents one of the sections 116.

The storage towers 112 can be configured in different shapes when viewed from above and/or the side in accordance with various embodiments. As one example, the storage tower 112 can have an octagonal, square, hexagonal, triangular, circular, or other polygonal shape when viewed from above. As another example, the storage tower 112 can have an octagonal column or cylinder, a circular cylinder, a cube, hexagonal column or cylinder, triangular column, or other three-dimensional polygonal shapes when viewed from the side. In some embodiments, at least two of the plurality of storage towers 112 can have different shapes. The shape of the sections 116 in the storage tower 112 can be selected to maximize the type of object that will be stored in that storage tower. If the storage tower 112 is to be used to store many large objects, a shape that affords the sections 116 with large widths, heights, or depths without leaving wasted space can be utilized. In some embodiments, one or more of the storage towers 112 in the system 100 can differ in functionality. For example, the system 100 can include a cooled storage tower 112 to store refrigerated or frozen objects. In some embodiments, the system 100 can include a heated storage tower 112 to store objects at above-ambient temperature. The system 100 can also include storage towers 112 with no temperature control that operate at ambient temperature.

Each storage tower 112 can include a plurality of shelf mounts 118 arranged vertically in each section 116 to store objects. In some embodiments, the shelf mounts 118 can be arranged vertically at regular or irregular intervals. In some embodiments, each object in the system 100 is supported by a tray. In some embodiments, the shelf mounts 118 can support the tray upon which the object is placed. By arranging a plurality of shelf mounts 118 vertically within one of the sections 116 of one of the storage towers 112, the tower can dynamically accommodate trays and associated objects having a range of volumes while minimizing empty space. For example, trays can be placed in one of the sections 116 at different heights such that each tray does not interfere with an object supported by another tray while placing the trays as close together as possible.

The crane 130 can be disposed outside of the storage towers 112. For example, the crane 130 can be mounted on or near a wall 101 and proximate to the dispensing window 110. The crane 130 can be vertically aligned with the dispensing window 110 in some embodiments. In some embodiments, the crane 130 can translate vertically to access objects at different vertical positions within one of the storage towers 112 that is positioned proximate to the dispensing window 110. By positioning the crane 130 outside of the storage towers 112, the crane 130 retrieves objects from the outside of the towers rather than from an axially central shaft within the storage tower 112. Thus, the volume within the tower that would have otherwise provided a shaft for the crane to operate is instead available for object storage. The crane 130 can selectively retrieve an object or objects from one or more storage towers 112 and deliver the object or objects to the dispensing window 110. In some embodiments, the crane 130 can transport the tray associated with an object to the dispensing window 110.

In conventional systems, the storage tower has an exterior wall to prevent unauthorized access to objects stored in the storage tower. As a result, objects can only be loaded for storage from the interior of the tower. Advantageously, the storage towers 112 described herein can have no exterior wall around the outside of the storage tower 112 because the wall 101 can prevent unauthorized access. As a result, the crane 130 can access items from the exterior of the storage tower 112. In addition, multiple objects can be loaded into the tower from the outside simultaneously using a moveable rack 160 as described in greater detail below.

In accordance with various embodiments, the transport platform 120 can be operationally coupled to one or more motors 138 that can be actuated to allow the transport platform 120 to rotate or translate. The transport platform 120 can support the storage towers 112 and can be configured to position at least one of the storage towers 112 proximate to the dispensing window 110. As shown in FIG. 2, the transport platform 120 can be a rotating platform that rotates about a central axis 103 (directed out of the page). In some embodiments, the motor 138 is operationally coupled to a shaft of the transport platform 120 that passes through the central axis 103.

In some embodiments, a platform sensor assembly 140 can detect the rotational or translational position of the transport platform 120. The platform sensor assembly 140 can include a first component 141 and a second component 142 in some embodiments. The first component 141 can be mounted to the transport platform 120 or to an object engaged with the transport platform 120. The second component 142 can be mounted to a wall 101 or other object that does not move with movement of the transport platform 120. In some embodiments, one of the first and second components can include an optical source that produces a beam of light (e.g., infrared light) while the other of the first and second components can include an optical detector. In some embodiments, one of the first and second components can include both the optical source and optical detector while the other of the first and second components can include a reflecting element such as a mirror. In some embodiments, one of the first component 141 and the second component 142 can include visual indicators (e.g., marks) and the other of the first component 141 and the second component 142 can include an optical sensor such as a camera. As the transport platform 120 moves or translates, the optical sensor can see the visual indicators. In some embodiments, the platform sensor assembly can include a rotational encoder, e.g., that includes a Hall effect sensor as the first component 141 and a magnet as the second component 142. In some embodiments, the platform sensor assembly 140 can send a signal to a computing device when the transport platform 120 is in a position such that one of the storage towers 112 is proximate to the dispensing window 110. While the platform sensor assembly 140 is shown as being disposed in an illustrative position in FIG. 2, the platform sensor assembly 140 can be disposed in other location in accordance with exemplary embodiments of the present disclosure. For example, the platform sensor assembly 140 can be disposed proximate to the motor, where the first component 141 is disposed on a shaft of the motor and the second component 142 is disposed at a fixed reference location.

Each of the storage towers 112 can be operationally coupled to a sub-platform disposed on or integrated with the platform 120. The sub-platforms can rotate the storage towers 112. In some embodiments, the sub-platforms can be operatively coupled to a stepper motor. The sub-platforms can rotate each of the towers to orient a desired section 116 of the towers to be in proximity to the crane 130 or dispensing window 110. In some embodiments, a tower sensor assembly 145 can detect the rotational position or rotational angle of the storage tower 112. The tower sensor assembly 145 can include a first component 146 and a second component 147 in some embodiments. The first component 146 can be mounted to the storage tower 112 or to an object engaged with the storage tower 112. The second component 142 can be mounted to a wall 101, the transport platform 120, or another object that does not move with rotation of the storage tower 112. In some embodiments, one of the first and second components can include an optical source that produces a beam of light (e.g., infrared light) while the other of the first and second components can include an optical detector. In some embodiments, one of the first and second components can include both the optical source and optical detector while the other of the first and second components can include a reflecting element such as a mirror. In some embodiments, the tower sensor assembly 145 can include a rotational encoder, e.g., that includes a Hall effect sensor as the first component 146 and a magnet as the second component 147. In some embodiments, the tower sensor assembly 145 can send a signal to a computing device when the desired section 116 of the storage tower 112 is proximate to the dispensing window 110. While the tower sensor assembly 145 is shown as being disposed in an illustrative position in FIG. 2, the tower sensor assembly 145 can be disposed in other locations in accordance with exemplary embodiments of the present disclosure. For example, the tower sensor assembly 145 can be disposed proximate to the motor, where the first component 146 is disposed on a shaft of the motor and the second component 147 is disposed at a fixed reference location.

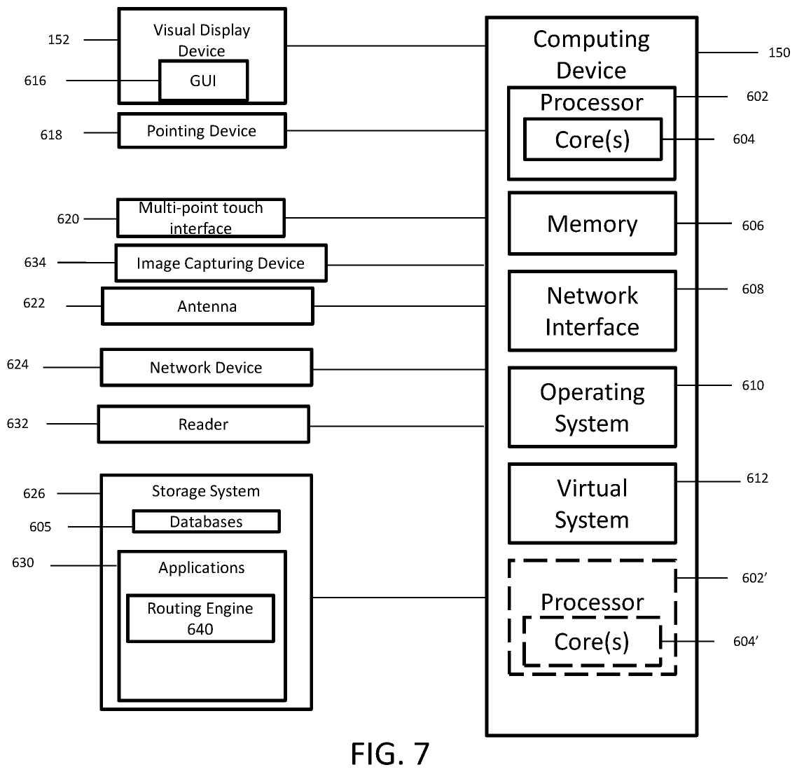

The system 100 can include a computing device 150 in some embodiments. The computing device 150 can communicate with, connect with, and/or control the crane 130, dispensing window 110, transport platform 120, storage towers 112, tower sensor assembly 145, platform sensor assembly 140, or terminals 152. Communication between computing device 150 and other elements of the system 100 can be performed using wired or wireless communication technologies. An exemplary computing device 150 is described in more detail below with reference to FIG. 7.

As described above, the system 100 positions one of the storage towers 112 (e.g., the storage tower 112 holding the object to be retrieved) proximate to the dispensing window 110 in response to input from a user. In some embodiments, the computing device 150 can receive user input in the form of a request from a user to deliver an object to the dispensing window 110. For example, a user can request retrieval of an object using the terminal 152. The terminal 152 can include a touch-screen interface in some embodiments to facilitate ease of use for the user. For example, a user may request that the system 100 dispense a pre-packaged order that is stored on one of the towers.

The computing device 150 can identify that object or objects requested by the user are stored in at least one of the storage towers 112 in the system 100. For example, the computing device 150 can include a database 605 in some embodiments that includes information about objects stored in the system 100. In some embodiments, information about the objects can include identifying information for the object itself such as universal product codes or dimensional information about the objects. In some embodiments, the information can include a location of the object within the system such as an identifier for a storage tower 112 or section 116 within a storage tower 112. The computing device 150 can check the requested object against information in the database 605 to identify if the requested object is held in one of the storage towers 112 in some embodiments.

The computing device 150 can control the transport platform 120 to position at least one of the storage towers 112 proximate to the dispensing window 110. For example, the computing device 150 can control motors that are operatively coupled to the transport platform 120 to rotate or translate the transport platform 120. In some embodiments, the computing device 150 can receive signals from the transport sensor assembly 140 that indicate the position of the transport platform 120 and can halt motion of the transport platform 120 when the correct storage tower 112 is proximate to the dispensing window 110. The computing device 150 can also control the transport platform 120 to rotate one of the sub-platforms that correspond to the at least one storage tower 112 positioned proximate to the dispensing window 110 until the requested object is accessible by the crane 130. In some embodiments, the computing device 150 can receive signals from the tower sensor assembly 145 that indicate the rotational position or angle of the storage tower 112 and can halt motion of the rotation of the storage tower when it is in the correct position (e.g. when the section including the object is oriented so that the crane can retrieve the object from the storage tower). The computing device 150 can control the crane 130 to retrieve the object and deliver the object to the dispensing window 110 in some embodiments.

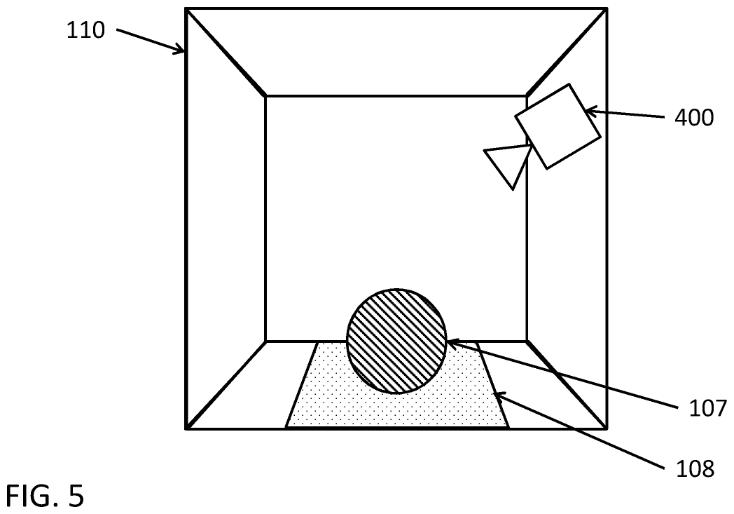

In some embodiments, the storage and retrieval system 100 can be used not only to retrieve objects that have been previously stored but also to store new objects. The computing device 150 can receive a request to store a new object. For example, the user can provide a request to store the new object via the terminal 152. The computing device 150 can control a dimensional scanner 400 (shown in FIG. 5) to identify a height and a width of the new object.

The computing device 150 can locate an empty volume in one of the plurality of sections 116 of the storage towers 112 capable of accommodating the width, length, and height of the new object. For example, the computing device 150 can determine, based upon information in the database 605, the dimensions of empty volumes in the storage towers 112 and to compare the determined empty volumes with the measured width and height of the new object to select the empty volume. In some embodiments, the computing device 150 can select the empty volume with the closest volume constraints to the volume of the new object. By fitting the new object into the empty volume of similar size, total free space in the system 100 is maximized by avoiding fragmentation of the volume.

The computing device 150 can control the transport platform 120 to position and rotate the selected storage tower 112 to position the empty volume proximate to the crane 130. The computing device 150 can control the transport platform 120 as described above. The computing device 150 can control the crane 130 to place the new object into the empty volume. For example, the new object can be placed on a tray in some embodiments. The computing device 150 can then control the crane 130 to move the tray to insert the new object into the empty volume.

In some embodiments, users can store objects in the object storage and retrieval system 100 by providing the object to the system 100 through the dispensing window 110 as described in greater detail below. In some embodiments, facility employees can add objects onto storage towers 112 from behind the wall 101. For example, orders that were placed in advance or remotely (e.g., through the Internet or phone orders or by a customer in another section of the facility) can be packaged behind the wall 101 by an employee and added to a storage tower 112. The user can then retrieve the object from the system 100 through the dispensing window 110.

Because a user can walk up to the object storage and retrieval system 100 and request retrieval of an object at any time, it is desirable to avoid system downtime that would force a user to wait to retrieve their package. Although objects can be loaded onto storage towers 112 through the dispensing window 110 in some embodiments, loading single objects using this interface is time-consuming. However, system downtime can occur during package loading by employees as the system 100 is typically locked into position to avoid sudden rotation or shifting of the towers during loading of objects behind the wall 101. In some embodiments, the object storage and retrieval system 100 can include a moveable rack 160 to quickly load one or more objects onto a storage tower 112 simultaneously. As a non-limiting example, the moveable rack 160 can include shelf mounts that can be arranged vertically to receive one or more trays supporting objects. Aspects of the shelf mounts in the moveable rack 160 (e.g., vertical spacing between shelf mounts and number of shelf mounts) can mimic the same aspects of shelf mounts in a section 116 of the storage towers 112. Trays supporting objects can be pre-loaded onto the vertically arranged shelf mounts of the moveable rack 160. Then, the moveable rack 160 can simultaneously transfer the trays supporting objects to one of the sections 116 in a selected storage tower 112. For example, the moveable rack 160 can slide laterally into position to load the objects into the storage tower 112 when the storage tower 112 and transport platform 120 are properly oriented.

In some embodiments, the object storage and retrieval system 100 can include a second dispensing window 110a. The second dispensing window 110a can accept requests from a second user at the same time that the first dispensing window 110 is accepting requests from the first user. In some embodiments, the object requested by the second user may be available on the storage tower 112 that is already proximate to the second dispensing window 112. In that case, the storage tower 112 can rotate to place the section including the requested object proximate to the second dispensing window 110a. Then, a second crane 130 can retrieve the object and deliver it to the second dispensing window 110a. If the second user requests an object that is not available on the storage tower 112 that is proximate to the second dispensing window 110a, the system 100 may delay action until the first user completes their transaction. Once the first user has completed their transaction, the system 100 can rotate the transport platform 120 to place the correct storage tower 112 proximate to the second dispensing window 110a. Although the wall 101 connecting the first dispensing window 110 and second dispensing window 110a is depicted as having straight sides, it is also contemplated that the wall 101 could be curved, e.g., to fit the profile of the transport platform 120.

The second crane 130 is disposed outside of the storage towers 112. For example, the second crane 130 can be mounted to the external wall 101. The second crane 130 is configured to selectively retrieve at least one of the stored objects from a second storage tower 112 different than the first storage tower 112 that is proximate to the dispensing window 110. The second crane 130 can deliver objects from the second tower 112 to the second dispensing window 110a. As noted above, the second crane 130 can be configured to retrieve objects from the second storage tower 112 while the first crane 130 retrieves objects from the first storage tower 112.

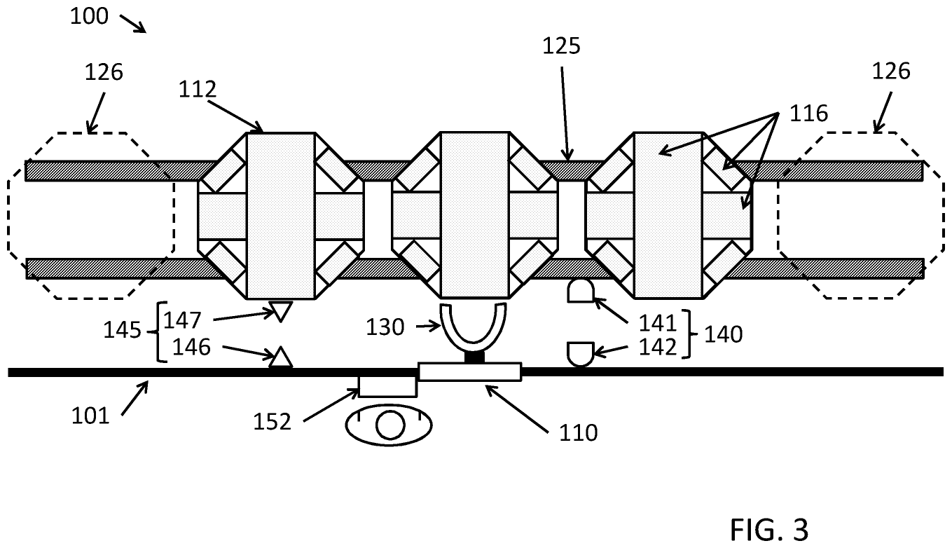

FIG. 3 illustrates a top schematic view of an embodiment of the object storage and retrieval system 100 including translating storage towers 112. The system 100 can include a transport platform 125, one or more storage towers 112, the dispensing window 110, and the crane 130.

The transport platform 125 can include rails, wheels, or other means to impart lateral movement to the storage towers 112. For example, the transport platform 125 can include a linear track in some embodiments. In some embodiments, the transport platform 125 includes a rigid element that connects the storage towers 112 such that the towers move in unison. For example, the towers 112 depicted in FIG. 3 can all slide to the left or right in some embodiments such that the left-most tower is positioned proximate to the dispensing window 110 when the right-most storage tower is located in a parked position 126. Similarly, the right-most tower can be positioned proximate to the dispensing window 110 when the left-most storage tower is located in the parked position 126. In other embodiments, the storage towers 112 can be unattached to one another and can move independently.

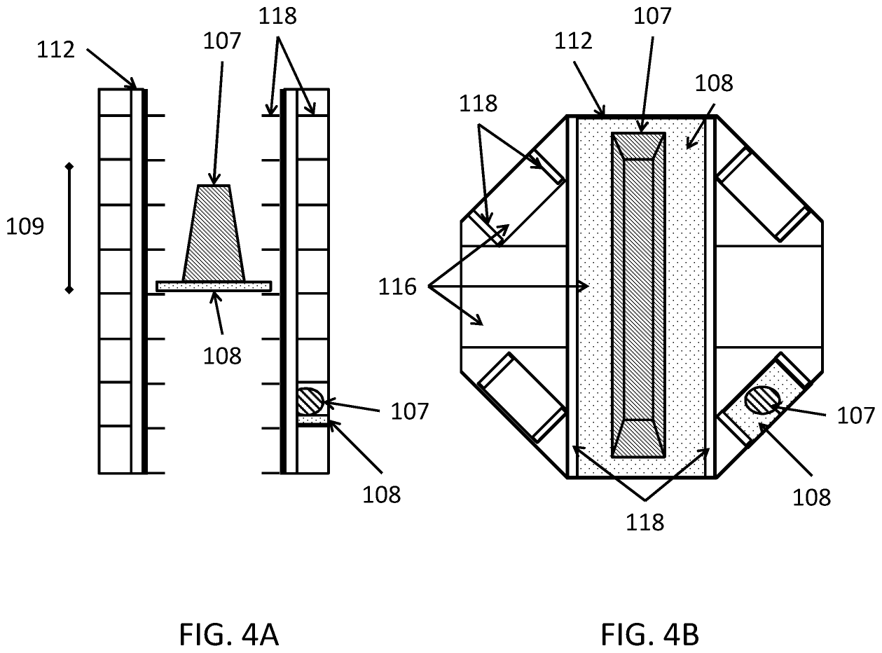

FIGS. 4A and 4B illustrate side and top views, respectively, of an exemplary storage tower 112 in accordance with various embodiments described above. As shown, the plurality of shelf mounts 118 can support the tray 108 supporting the object 107 that is stored. By providing many shelf mounts 118 at different vertical positions within a section 116, the volume within the section can be configured to accommodate many objects with minimal wasted space. For example, the computing device 150 can identify one or more dimensions of the objects 107 using a dimensional scanner 400. Based upon the identified dimensions, the computing device 150 can determine which section 116 is most appropriate to store the object (i.e., based upon width or length constraints). Then, the computing device 150 can control the crane 130 to place the object 107 on shelf mounts 118 within a section 116 that avoids disrupting any previously stored objects. For example, the computing device 150 can maintain a record that the vertical space 109 is unoccupied and that the object 107 fits within the empty volume defined by that vertical space 109.

FIG. 5 illustrates a front view of the dispensing window 110 in some embodiments. The system 100 can include a dimensional scanner 400 in some embodiments. The dimensional scanner 400 can identify one or more dimensions of a new object to be stored in the storage towers 112 of the system. For example, the dimensional scanner 400 can identify a width, height, depth, volume, weight, or other physical property of the object. The dimensional scanner 400 can include an imaging system in some embodiments. Based upon an analysis of images acquired by the imaging system, the dimension can be identified. In some embodiments, the dimensional scanner can include a laser scanner.

In some embodiments, the computing device 150 is in communication with the dimensional scanner 400. Based upon dimensions received by the computing device 150 from the dimensional scanner 400, the computing device 150 can make a recommendation of tray size (e.g., tray of a certain width or depth) to the user.

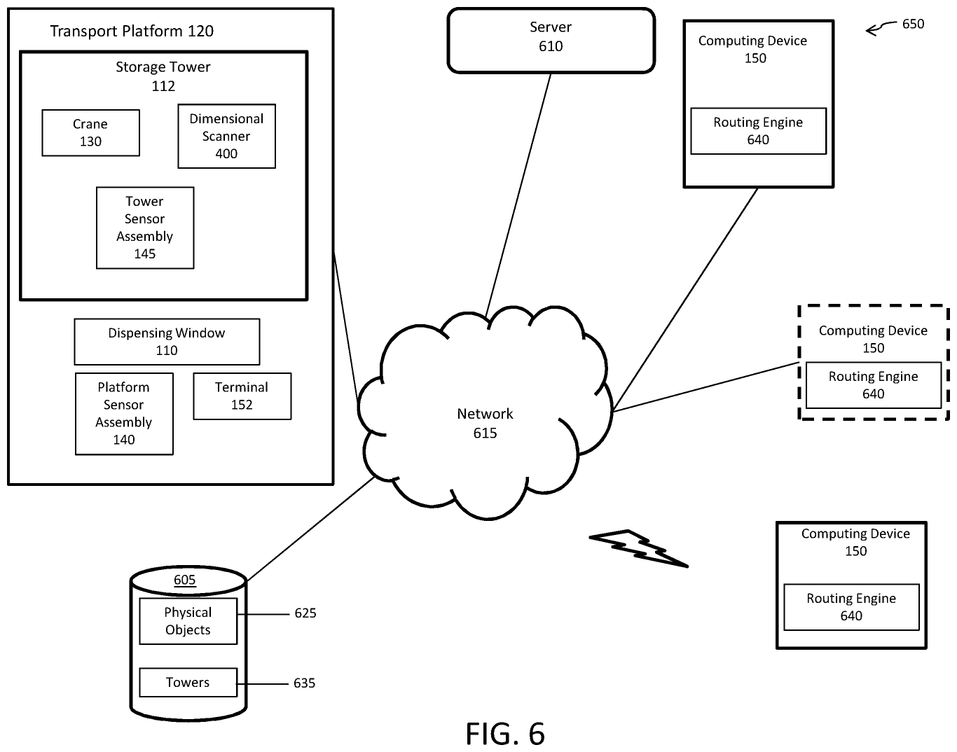

FIG. 6 illustrates an exemplary object storage and retrieval system 650 in accordance with an exemplary embodiment. The object storage and retrieval system 650 can include one or more databases 605, one or more servers 610, one or more computing devices 150, and one or more transport platforms 120 with associated storage towers 112, dispensing windows 110, platform sensor assemblies 140, and terminals 152. Each of the storage towers 112 can include a crane 130, dimensional scanner 400, and a tower sensor assembly 145. The computing device 150 can include a routing engine 640. The routing engine 640 can implement the object storage and retrieval system 650.

The server 610 includes one or more computers or processors configured to communicate with the computing device 150, the databases 605, and transport platform 120 via a communications network 615. The server 610 hosts one or more applications configured to interact with one or more components of the computing device 150 and/or facilitates access to the content of the databases 605. The databases 605 may store information/data, as described herein. For example, the databases 605 can include a physical objects database 625 and a towers database 635. The physical objects database 625 can store information associated with physical objects. The towers database 635 can store information associated with the location or position of the storage towers 112 and the physical object or objects disposed in the storage towers 112. The databases 605 can be located at one or more geographically distributed locations from the computing device 150. Alternatively, the databases 605 can be located at the same geographical location as the computing device 150.

In an example embodiment, one or more portions of the communications network 615 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

In exemplary embodiments, the transport platform 120 and associated storage towers 112 can be disposed in a facility. The storage towers 112 can be disposed adjacent to one another. Physical objects can be disposed in the storage towers 112.

A user can request a physical object to be dispensed from a storage tower 112. The user can input identification information associated with the physical object at the terminal 152 or at a separate user device (i.e., mobile telecommunications device). The processor 602 of the computing device 150 can receive the identification information and control the transport platform 120, storage towers 112, and crane 130 to deliver the object to the dispensing window 110.

The computing device 150 can receive the identification information associated with the physical object and execute the routing application 640. The routing application 640 can query the physical objects database 625 to retrieve information associated with the physical object including the storage tower 112 in which the physical object is disposed and the ownership information of the physical object. The routing application 640 can query the towers database 635 to retrieve information associated with the storage tower 112 in which the physical object is disposed.

In one embodiment, the routing engine 640 can determine an estimated time to retrieve the object and provide the estimated time to the user, e.g., through the terminal.

As a non-limiting example, the storage and retrieval system 650 can be implemented in a retail store. The transport platform 120 and associated storage towers 112 can be disposed at the retail store. The physical object can be products purchased or about to be purchased by users from the retail store. The user can be a customer of the retail store and can pick-up products from the storage towers 112. As an example, the user can purchase something online and pick-up the product from the storage tower 112. Alternatively, or in addition to, the user can use the terminal 152 associated with the system and/or a Point-of-Sale (POS) terminal of the retail store to purchase a product and pick-up the product from the dispensing window 110.

FIG. 7 is a block diagram of an example computing device for implementing exemplary embodiments of the present disclosure. The computing device 150 may be, but is not limited to, a smartphone, laptop, tablet, desktop computer, server, or network appliance. The computing device 150 can be embodied as part of the computing device or storage tower. The computing device 150 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 606 included in the computing device 150 may store computer-readable and computer-executable instructions or software (e.g., applications 630 such as the routing engine 640) for implementing exemplary operations of the computing device 150. The computing device 150 also includes configurable and/or programmable processor 602 and associated core(s) 604, and optionally, one or more additional configurable and/or programmable processor(s) 602′ and associated core(s) 604′ (for example, in the case of computer systems having multiple processors/cores), for executing computer-readable and computer-executable instructions or software stored in the memory 606 and other programs for implementing exemplary embodiments of the present disclosure. Processor 602 and processor(s) 602′ may each be a single core processor or multiple core (604 and 604′) processor. Either or both of processor 602 and processor(s) 602′ may be configured to execute one or more of the instructions described in connection with computing device 150.

Virtualization may be employed in the computing device 150 so that infrastructure and resources in the computing device 150 may be shared dynamically. A virtual machine 612 may be provided to handle a process running on multiple processors so that the process appears to be using only one computing resource rather than multiple computing resources. Multiple virtual machines may also be used with one processor.

Memory 606 may include a computer system memory or random access memory, such as DRAM, SRAM, EDO RAM, and the like. Memory 606 may include other types of memory as well, or combinations thereof.

A user may interact with the computing device 150 through a visual display device 152, such as a computer monitor, which may display one or more graphical user interfaces 616. The user may interact with the computing device using a multi-point touch interface 620, a pointing device 618, an image capturing device 634, or a reader 632.

The computing device 150 may also include one or more computer storage devices 626, such as a hard-drive, CD-ROM, or other computer readable media, for storing data and computer-readable instructions and/or software that implement exemplary embodiments of the present disclosure (e.g., applications). For example, exemplary storage device 626 can include one or more databases 605 for storing information regarding physical objects and the storage towers. The databases 605 may be updated manually or automatically at any suitable time to add, delete, and/or update one or more data items in the databases.

The computing device 150 can include a network interface 608 configured to interface via one or more network devices 624 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device can include one or more antennas 622 to facilitate wireless communication (e.g., via the network interface) between the computing device 150 and a network and/or between the computing device 150 and other computing devices. The network interface 608 may include a built-in network adapter, network interface card, PCMCIA network card, card bus network adapter, wireless network adapter, USB network adapter, modem or any other device suitable for interfacing the computing device 150 to any type of network capable of communication and performing the operations described herein.

The computing device 150 may run any operating system 610, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 150 and performing the operations described herein. In exemplary embodiments, the operating system 610 may be run in native mode or emulated mode. In an exemplary embodiment, the operating system 610 may be run on one or more cloud machine instances.

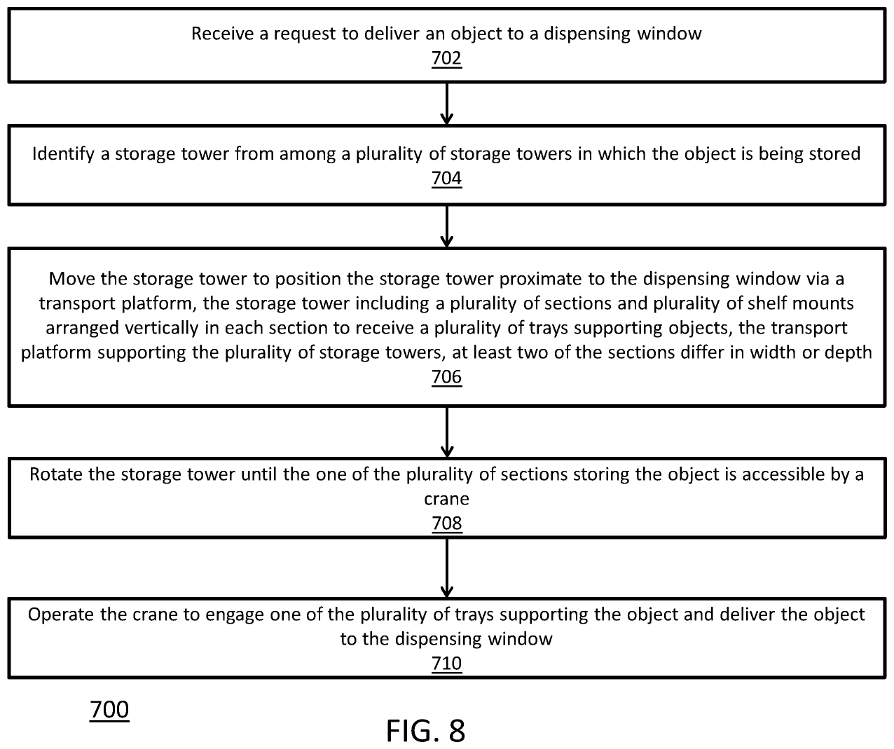

FIG. 8 illustrates a flowchart for a method of storing and delivering objects in accordance with embodiments described herein. The method 700 includes receiving a request to deliver an object to a dispensing window (step 702). The method 700 includes identifying a storage tower from among a plurality of storage towers in which the object is being stored (step 704). The method 700 includes moving the storage tower to position the storage tower proximate to the dispensing window via a transport platform (step 706). The storage tower includes a plurality of sections and a plurality of shelf mounts arranged vertically in each section to receive a plurality of trays supporting objects. The transport platform supports the plurality of storage towers, and at least two of the sections differ in width or depth. The method 700 includes rotating the storage tower until the one of the plurality of sections storing the object is accessible by a crane (step 708). The method 700 includes operating the crane to engage one of the plurality of trays supporting the object and deliver the object to the dispensing window (step 710).

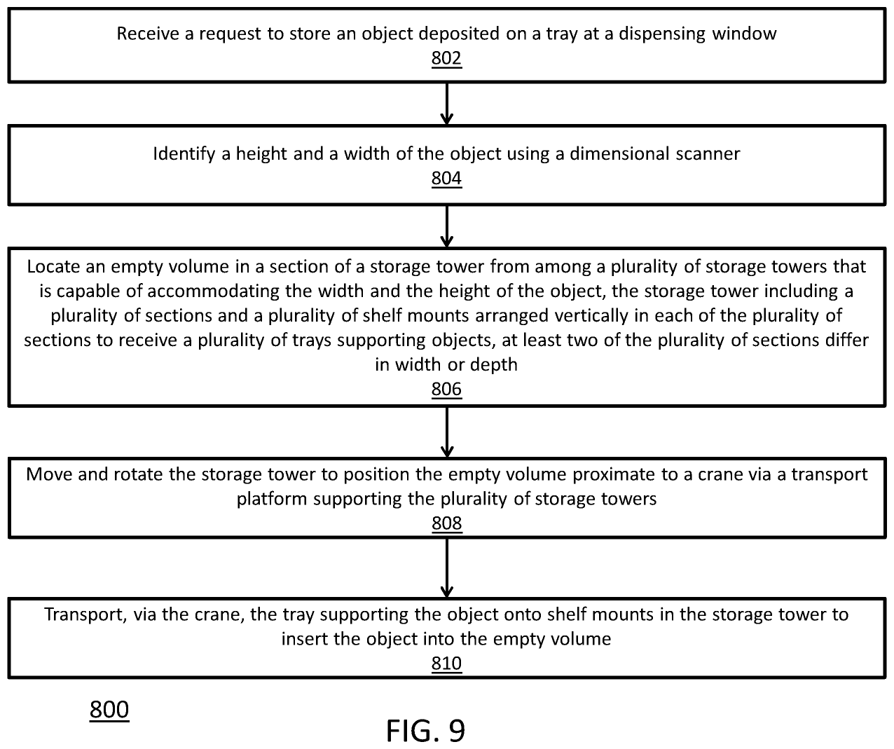

FIG. 9 illustrates a flowchart for a method of storing objects in accordance with embodiments described herein. The method 800 includes receiving a request to store an object deposited on a tray at a dispensing window (step 802). The method 800 includes identifying a height and a width of the object using a dimensional scanner (step 804). The method 800 includes locating an empty volume in a section of a storage tower from among a plurality of storage towers that is capable of accommodating the width and the height of the object (step 806). The storage tower includes a plurality of sections and a plurality of shelf mounts arranged vertically in each of the plurality of sections to receive a plurality of trays supporting objects. At least two of the plurality of sections differ in width or depth. The method 800 includes moving and rotating the storage tower to position the empty volume proximate to a crane via a transport platform supporting the plurality of storage towers (step 808). The method 800 includes transporting, via the crane, the tray supporting the object onto shelf mounts in the storage tower from the dispensing window to insert the object into the empty volume (step 810).

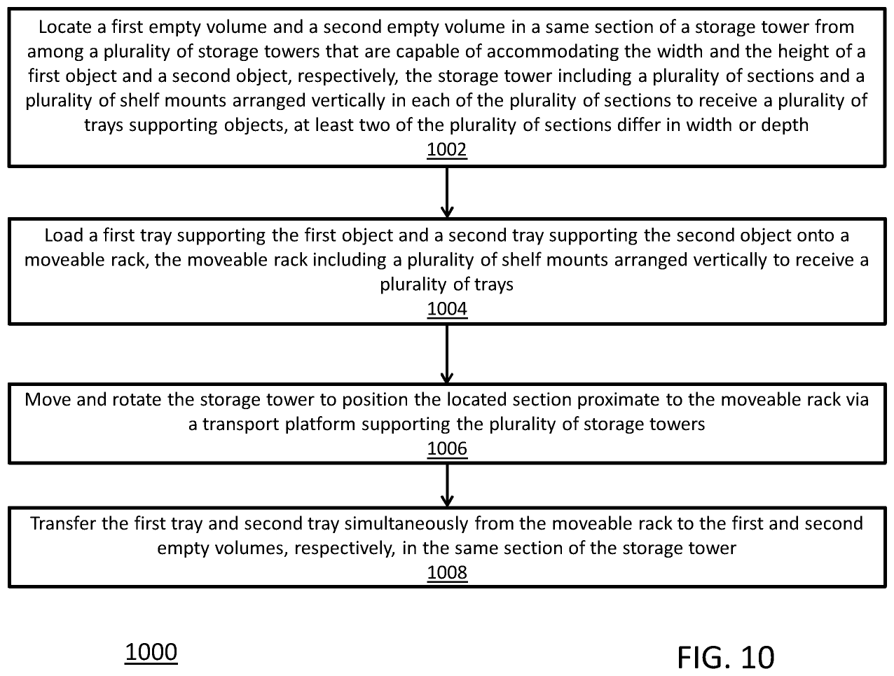

FIG. 10 illustrates a flowchart for a method of simultaneous storage of objects in accordance with embodiments described herein. The method 1000 includes locating a first empty volume and a second empty volume in a same section of a storage tower from among a plurality of storage towers that are capable of accommodating the width and the height of a first object and a second object, respectively (step 1002). The storage tower includes a plurality of sections and a plurality of shelf mounts arranged vertically in each of the plurality of sections to receive a plurality of trays supporting objects. At least two of the plurality of sections differ in width or depth. The method 1000 includes loading a first tray supporting the first object and a second tray supporting the second object onto a moveable rack (step 1004). The moveable rack includes a plurality of shelf mounts arranged vertically to receive a plurality of trays. The method 1000 includes moving and rotating the storage tower to position the located section proximate to the moveable rack via a transport platform supporting the plurality of storage towers (step 1006). The method 1000 includes transferring the first tray and the second tray simultaneously from the moveable rack to the first and second empty volumes, respectively, in the same section of the storage tower (step 1008).

1. A storage and retrieval system, comprising:
a plurality of storage towers, each storage tower including:
a plurality of sections wherein at least two of the sections differ in width or depth, and
a plurality of shelf mounts arranged vertically in each section to store objects;
a dispensing window;
a transport platform configured to support the plurality of storage towers, the transport platform being configured to position at least one of the plurality of storage towers proximate to the dispensing window; and
a crane disposed outside of the plurality of storage towers and vertically aligned with the dispensing window, the crane configured to selectively retrieve at least one of the objects from the at least one of the plurality of storage towers and to deliver the at least one of the objects to the dispensing window,
wherein the at least one of the plurality of storage towers is positioned proximate to the dispensing window in response to input from a user.

2. The system of claim 1, wherein each of the objects is supported by a tray and wherein the crane delivers the at least one of the objects by transporting the tray associated with the at least one of the objects to the dispensing window.

3. The system of claim 1, further comprising a computing device configured to execute instructions to:
receive a request to deliver the at least one of the objects to the dispensing window as the user input;
identify that the at least one of the objects is stored in the at least one of the plurality of storage towers;
control the transport platform to position the at least one of the plurality of storage towers proximate to the dispensing window;
control the transport platform to rotate the at least one of the storage towers until the at least one of the objects is accessible by the crane; and
control the crane to retrieve the object and deliver the object to the dispensing window.

4. The system of claim 1, further comprising a dimensional scanner to identify one or more dimensions of a new object to be stored in the plurality of storage towers.

5. The system of claim 4, further comprising a computing device configured to execute instructions to:
receive a request to store the new object;
control the dimensional scanner to identify a height and a width of the new object;
locate an empty volume in one of the plurality of sections of the plurality of storage towers capable of accommodating the width and height of the new object;
control the transport platform to position and rotate a selected one of the plurality of storage towers to position the empty volume proximate to the crane; and
control the crane to place the new object into the empty volume.

6. The system of claim 5, wherein the new object is placed on a tray and the step of controlling the crane to place the new object into the empty volume includes moving the tray with the crane to insert the object into the empty volume.

7. The system of claim 1 wherein the transport platform rotates about a central axis.

8. The system of claim 1 wherein the transport platform translates along a linear track.

9. The system of claim 1, wherein each of the plurality of storage towers has an octagonal shape.

10. The system of claim 1, wherein each of the plurality of storage towers includes at least three sections, and each of the at least three section have different widths or depths.

11. The system of claim 1, further comprising:
a second dispensing window; and
a second crane disposed outside of the plurality of storage towers and vertically aligned with the second dispensing window, the crane configured to selectively retrieve at least one of the objects from at least a second tower of the plurality of storage towers different than the at least one of the plurality of storage towers and to deliver the at least one of the objects from the second tower to the second dispensing window,
wherein the second crane is configured to retrieve objects from the second tower while the first crane retrieves objects from the at least one of the plurality of storage towers.

12. The system of claim 1, further comprising a moveable rack including a plurality of shelf mounts arranged vertically to receive a plurality of trays supporting objects wherein the moveable rack simultaneously transfers the plurality of trays to one of the plurality of sections of a selected one of the plurality of storage towers.

13. The system of claim 1, further comprising at least one platform sensor assembly to identify a position of the transport platform and at least one tower sensor assembly to identify a rotation angle of the at least one of the plurality of storage towers.

14. The system of claim 1, wherein a depth of at least one of the plurality of sections is equal to a distance between a first side of the storage tower and a second side of the storage tower opposite the first side.

15. A method of storing and delivering objects, comprising:
receiving a request to deliver an object to a dispensing window;
identifying a storage tower from among a plurality of storage towers in which the object is being stored;
positioning the storage tower proximate to the dispensing window via a transport platform, the storage tower including a plurality of sections and a plurality of shelf mounts arranged vertically in each section to receive a plurality of trays supporting objects, the transport platform supporting the plurality of storage towers, at least two of the sections differ in width or depth;
rotating the storage tower until the one of the plurality of sections storing the object is accessible by a crane; and
operating the crane to engage one of the plurality of trays supporting the object and deliver the object to the dispensing window.

16. The method of claim 15, further comprising sensing, using at least one platform sensor assembly, a position of the transport platform.

17. The method of claim 15, further comprising sensing, using at least one tower sensor assembly, a rotation angle of the storage tower.

18. The method of claim 15, further comprising simultaneously transferring a plurality of trays supporting objects arranged vertically on a plurality of shelf mounts of a moveable rack onto one of the plurality of sections of the storage tower.

19. The method of claim 15, wherein the crane is positioned externally to the plurality of storage towers.

20. A method of storing objects, comprising:
receiving a request to store an object deposited on a tray at a dispensing window;
identifying a height and a width of the object using a dimensional scanner;
locating an empty volume in a section of a storage tower from among a plurality of storage towers that is capable of accommodating the width and the height of the object, the storage tower including a plurality of sections and a plurality of shelf mounts arranged vertically in each of the plurality of sections to receive a plurality of trays supporting objects, at least two of the plurality of sections differ in width or depth;
positioning and rotating the storage tower to position the empty volume proximate to a crane via a transport platform supporting the plurality of storage towers;
transporting, via the crane, the tray supporting the object onto shelf mounts in the storage tower to insert the object into the empty volume.

21. The method of claim 20, wherein the crane is positioned externally to the plurality of storage towers.
